(19) United States
(12) Patent Application Publication
(10) Pub. No.: US 2023/0131159 A1
(43) Pub. Date: Apr. 27, 2023

(54) Method for Operating an IS Machine for Producing Glass Containers

(71) Applicant: Heye International GmbH, Obemkirchen (DE)

(72) Inventors: Ralf Schöttelndreier, Nienstädt (DE); Thomas Hartmann, Bückeburg (DE); Dirk Winkelhake, Nienstädt (DE)

(21) Appl. No.: 17/973,059

(22) Filed: Oct. 25, 2022

(30) Foreign Application Priority Data
Oct. 26, 2021 (DE) 10 2021 127 832.5

(51) Int. Cl. C03B 9/20

(52) U.S. Cl. CPC C03B 9/20

(57) ABSTRACT

A method for operating an IS machine for producing glass containers includes: introducing a glass gob into a blank mold, producing a parison from the glass gob in the blank mold, transferring the parison into a finishing mold, actuating a vacuum valve for producing a vacuum in the finishing mold from a first actuating point in time and simultaneously measuring the evolution of the vacuum pressure, actuating a finish-blowing valve for generating a finish-blowing pressure from a second actuating point in time that is later than the first actuating point in time by a predetermined duration, such that compressed air is blown into the finishing mold from the top, and simultaneously measuring the evolution of the finish-blowing pressure and checking whether the evolution of the measured vacuum pressure and/or the evolution of the measured finish-blowing pressure has fulfilled a predetermined condition.

The invention relates to a method for operating an IS machine for producing glass containers, wherein the IS machine comprises a plurality of blank molds and a plurality of finishing molds and one blank mold interacts with one finishing mold in each case, comprising the following method steps, which are carried out for a pair of one blank mold and one finishing mold in each case:
introducing a glass gob into the blank mold,
producing a parison from the glass gob in the blank mold,
transferring the parison into the finishing mold,
actuating a vacuum valve for producing a vacuum in the finishing mold from a first actuating point in time and
actuating a finish-blowing valve for generating a finish-blowing pressure from a second actuating point in time that is later than the first actuating point in time by a predetermined duration, such that compressed air is blown into the finishing mold from the top.

The operation of an IS machine for producing glass containers has been known from the prior art for decades. In this respect, the terms “IS machine,” “blank mold,” “finishing mold,” “parison,” “blowing down,” “pre-blowing,” and “finish-blowing” are technical terms that are known to a person skilled in the art and therefore do not need to be explained in detail here. For the sake of clarity, the basic features of the operation of an IS machine as known from the prior art in a blow-blow process are briefly explained in the following:

Glass is liquefied in a melting end and flows out of the melting end into a feeder. An elongate glass gob is formed at the head of the feeder by means of a riser machine. This glass gob is conducted into a blank mold via a channel. The subsequent neck of the glass container to be produced points downward in this case. A blank mold base is then placed onto the blank mold and closes the blank mold. Compressed air is blown in from the top, such that the glass mass provided by the glass gob completely fills a neck mold fitted to the bottom of the blank mold. This step is called blowing down. In the following, the blank mold base is removed and the blank mold is closed at the top by a blank mold base. The glass is pre-blown into the opening thus formed at the bottom by compressed air flowing in to form the parison. The blank mold is opened and the pre-blown workpiece, i.e. the parison, is pivoted by 180° into the associated open finishing mold by a transfer mechanism. In this process, the parison is held in a neck mold. The neck is then at the top. The neck mold is then opened and the transfer mechanism pivots back into the starting position in order to receive the next parison in the blank mold. Meanwhile, the finishing mold is closed from the top by a blowing head in order to finish-blow the parison in the finishing mold by means of compressed air into its final form. The blowing head then pivots back, the finishing mold is opened and a gripper conveys the finished workpiece to a deadplate. In general, another mechanism then pushes the finished workpiece onto a belt, which conveys the article into a cooling region.

For the sake of completeness, it is noted that the above-described blow-blow process is certainly not the only process which can be used to produce glass containers by means of an IS machine. For example, it is also known to operate an IS machine using a press-blow process. In this process, the parison is not blown, but instead is pressed by a plunger inserted through the neck mold. This process was first used in wide-necked containers, but especially provides particular advantages in narrow-necked bottles.

Processes of this kind then result in the problem explained below: when the pressures for the finish-blowing on one hand and for generating the vacuum on the other hand arise at the same point in time, the pressures add up and the deformation speed of the glass increases. The increased processing speed can result in cracks, known as compression cracks. To prevent this, different start times for finish-blowing and the vacuum are set in an electronic timer as a rule. The time difference should be at least 50 ms. Since the time until a pressure actually arises is, however, influenced by a whole range of factors, such as switching hysteresis of the electronic timer, pilot air pressure, state of the valve, state of the switch cartridge, and also line length and diameter, until now it has been practically impossible to ensure that only those pressures develop that are desired and unproblematic for producing the glass containers. Therefore, glass containers are rejected time and again, since the time at which the respective pressures are applied is no longer as desired, at least after a certain operating time of the IS machine, and no longer correlates with the actuation of the relevant valve in a preset manner.

Proceeding therefrom, the problem addressed by the invention is to provide an option for allowing for this kind of operation of an IS machine in which rejects owing to defectively produced glass containers can be effectively identified and which additionally preferably only has a low reject rate of glass containers.

This problem is solved by the subject matter of claim 1. Preferred developments are found in the dependent claims.

According to the invention, a method for operating an IS machine for producing glass containers is thus provided, wherein the IS machine comprises a plurality of blank molds and a plurality of finishing molds and one blank mold interacts with one finishing mold in each case, comprising the following method steps, which are carried out for a pair of one blank mold and one finishing mold in each case:
introducing a glass gob into the blank mold,
producing a parison from the glass gob in the blank mold,
transferring the parison into the finishing mold,
actuating a vacuum valve for producing a vacuum in the finishing mold from a first actuating point in time and simultaneously measuring the evolution of the vacuum pressure,
actuating a finish-blowing valve for generating a finish-blowing pressure from a second actuating point in time that is later than the first actuating point in time by a predetermined duration, such that compressed air is blown into the finishing mold from the top, and simultaneously measuring the evolution of the finish-blowing pressure and
checking whether the evolution of the measured vacuum pressure and the evolution of the measured finish-blowing pressure has fulfilled a predetermined condition.

If the measurement of the evolution of the vacuum pressure and/or the measurement of the evolution of the finish-blowing pressure is being discussed here, these pressures are detected at a relevant point between the corresponding valve, i.e. the vacuum valve or the finish-blowing valve, on one hand and the point at which the vacuum pressure or the finish-blowing pressure enters the finishing mold on the other hand. The vacuum pressure and the finish-blowing pressure add up in the finishing mold itself. In this respect, in the context of the invention, it is possible to detect the relevant pressure in a corresponding feed line, i.e. in a vacuum feed line or in a finish-blowing feed line, and specifically between the vacuum valve or the finish-blowing valve on one hand and the finishing mold on the other hand.

It is then important for the invention that the evolution of the vacuum pressure and the evolution of the finish-blowing pressure are measured such that a check can be carried out as to whether the evolution of the measured vacuum pressure and/or the evolution of the measured finish-blowing pressure has fulfilled a predetermined condition. If this check indicates that the predetermined condition has not been fulfilled, various measures can be taken to eliminate defectively produced glass containers and where necessary to adapt the operation of the IS machine such that the reject rate is reduced further. In the context of the invention, there are various options for doing this, which are discussed in the following by way of example by preferred configurations of the invention being outlined.

From this perspective, according to a preferred embodiment of the invention, in the step of checking whether the evolution of the measured vacuum pressure and/or the evolution of the measured finish-blowing pressure has fulfilled a predetermined condition, a check is carried out as to whether the evolution of the measured vacuum pressure has a predetermined relation to the evolution of the measured finish-blowing pressure. In this way, a check can be carried out, for example, as to the evolution over time of the pressures relative to one another and in particular whether the finish-blowing pressure built up too soon after applying the vacuum, such that the total pressure acting on the glass is above a value at which defect-free production of the glass containers can be ensured as a rule.

In this connection, it is preferably provided in particular that, in the step of checking whether the evolution of the measured vacuum pressure has a predetermined relation to the evolution of the measured finish-blowing pressure, the duration between the points in time is determined at which the evolution of the finish-blowing pressure and/or the evolution of the vacuum pressure is at a maximum. In this connection, according to a preferred configuration of the invention, it is provided that, in the event that the check indicates that the duration between the points in time at which the evolution of the finish-blowing pressure and/or the evolution of the vacuum pressure is at a maximum is not in a predetermined duration range, the time at which the vacuum valve and/or the finish-blowing valve is actuated is changed in a subsequent actuation in order to adjust the duration between the points in time at which the evolution of the finish-blowing pressure and/or the evolution of the vacuum pressure is at a maximum such that it is moved into the predetermined duration range.

Another preferred configuration of the invention provides that, in the event that the check indicates that the duration between the points in time at which the evolution of the finish-blowing pressure and/or the evolution of the vacuum pressure is at a maximum is lower than a predetermined upper duration limit, a warning message is output. In addition, a preferred configuration of the invention is that, in the event that the check indicates that the duration between the points in time at which the evolution of the finish-blowing pressure and/or the evolution of the vacuum pressure is at a maximum is lower than a lower duration limit, the glass container during the production of which the duration fell below the lower duration limit is rejected.

As mentioned above, the time difference between the pressure peaks should generally be above 50 ms. In this respect, it is provided according to a preferred development of the invention that a glass container is rejected if a time difference between the pressure peaks of less than 50 ms has been identified for it. At a time of between e.g. 50 ms and 100 ms, it is preferably provided that warning messages are output to an operator of the IS machine. Preferably, moreover, the actuation of the vacuum valve and/or the finish-blowing valve is readjusted if this duration between the pressure peaks is not in a predetermined duration range of from 100 ms to 120 ms, for example.

A preferred configuration of the invention, which can be implemented as an alternative to or in addition to the above-described preferred configurations of the invention, provides that, in the step of checking whether the evolution of the measured vacuum pressure and/or the evolution of the measured finish-blowing pressure has fulfilled a predetermined condition, a check is carried out as to whether the evolution of the total of the vacuum pressure and the finish-blowing pressure has not exceeded a predetermined maximum pressure. This preferred development of the invention thus does not focus on the points in time of the pressure peaks, but instead carries out a direct check as to whether a predetermined maximum pressure has not been exceeded in the finishing mold. Preferably, in the event that the check indicates that the predetermined maximum pressure has been exceeded, the time at which the vacuum valve and/or the finish-blowing valve is actuated is changed in a subsequent actuation in order to adjust the evolution of the total of the vacuum pressure and the finish-blowing pressure such that the predetermined maximum pressure is no longer exceeded. In particular, in this case, the adjustment is set such that the ultimate pressure values of the vacuum pressure and the finish-blowing pressure are reached in the shortest possible time.

Similarly to what is described above, in the event that the maximum pressure is only exceeded by a first predetermined pressure difference, a warning message is output here too. In addition, in the event that the maximum pressure is exceeded by a second predetermined pressure difference which is greater than the first predetermined pressure difference, the glass container during the production of which the second predetermined pressure difference was exceeded is preferably rejected.

A preferred configuration of the invention, which can be implemented as an alternative to or in addition to the above-described preferred configurations of the invention, comprises the following additional method steps, which are carried out for a pair of one blank mold and one finishing mold in each case:
measuring the duration between the point in time of actuating the vacuum valve and the point in time at which the vacuum pressure has reached a predetermined vacuum pressure value, and
changing the time at which the vacuum valve is actuated in a subsequent actuation in order to adjust the duration between the point in time of actuating the vacuum valve and the point in time at which the vacuum pressure has reached a predetermined vacuum pressure value to a predetermined duration.

Owing to signs of aging of the vacuum valve, it may be that, despite the actuation time by means of the electronic timer remaining the same, said valve no longer opens and closes at the desired time. This can be counteracted by changing the time at which the vacuum valve is actuated, as described above. The same applies to the finish-blowing valve, such that, according to a preferred configuration of the invention, a method comprising the following additional method steps is provided, which are carried out for a pair of one blank mold and one finishing mold in each case:
measuring the duration between the point in time of actuating the finish-blowing valve and the point in time at which the finish-blowing pressure has reached a predetermined finish-blowing pressure value, and
changing the time at which the finish-blowing valve is actuated in a subsequent actuation in order to adjust the duration between the point in time of actuating the finish-blowing valve and the point in time at which the finish-blowing pressure has reached a predetermined finish-blowing pressure value to a predetermined duration.

However, the invention not only comprises detecting pressures which are fed to the finishing mold. In the context of a preferred development of the invention, to produce the blank, the glass gob is blown down in the blank mold by means of compressed air blown into the blank mold from the top and the glass gob is pre-blown in the blank mold to form a parison by means of compressed air blown into the blank mold from the bottom, wherein, in the step of blowing down the glass gob in the blank mold, a blowing-down valve is actuated to generate a blowing-down pressure in the blank mold from a third actuating point in time and the evolution of the blowing-down pressure is simultaneously measured,
in the step of pre-blowing the glass gob in the blank mold to form a parison, a pre-blowing valve is actuated to generate a pre-blowing pressure in the blank mold from a fourth actuating point in time that is later than the third actuating point in time by a predetermined duration and the evolution of the pre-blowing pressure is simultaneously measured, and the method comprises the following additional method step, which is likewise carried out for a pair of one blank mold and one finishing mold in each case:
checking whether the evolution of the measured blowing-down pressure and/or the evolution of the measured pre-blowing pressure has fulfilled a predetermined condition.

This makes it possible to coordinate the duration and the time offset between blowing down and pre-blowing, for example, and specifically irrespective of the values set in an electronic timer used to actuate the valves. In this way, further container defects can be counteracted, such as bumps in the neck of a bottle or inhomogeneous glass distribution.

Preferred configurations when detecting pressures fed to the blank mold become clear by analogy with the above-described preferred configurations of the invention in conjunction with the finishing mold. Therefore, for example, according to a preferred development of the invention it is provided to determine the duration between the pressure peaks in order to change the actuation of the blowing-down valve and/or the pre-blowing valve on the basis thereof, for example to adjust it to a predetermined duration between the pressure peaks. Moreover, a warning message can certainly also be provided if desired time differences are not adhered to.

In the following, the invention will be explained in greater detail on the basis of a preferred exemplary embodiment with reference to the drawings, in which:

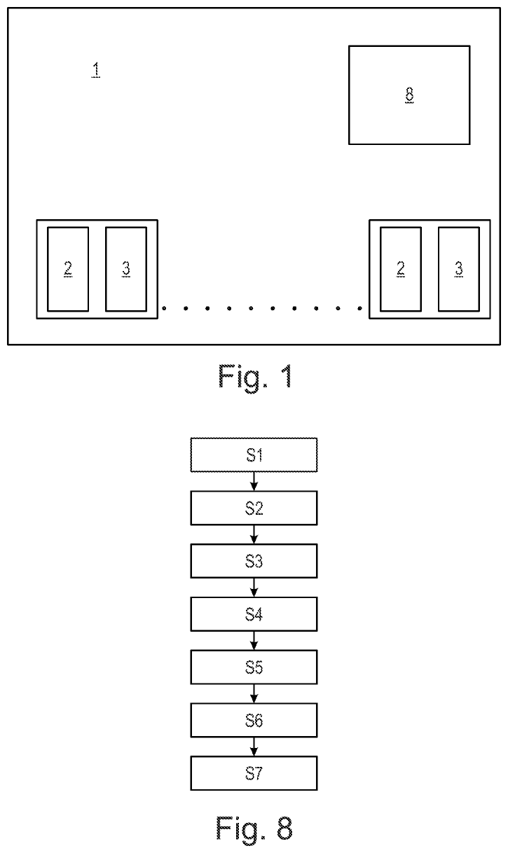

FIG. 1 schematically shows an IS machine according to a preferred exemplary embodiment of the invention,

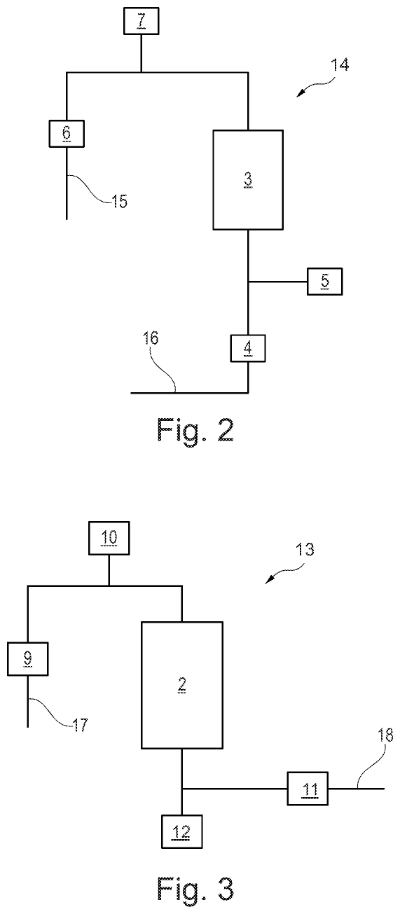

FIG. 2 schematically shows a finishing mold system of the IS machine from FIG. 1,

FIG. 3 schematically shows a blank mold system of the IS machine from FIG. 1,

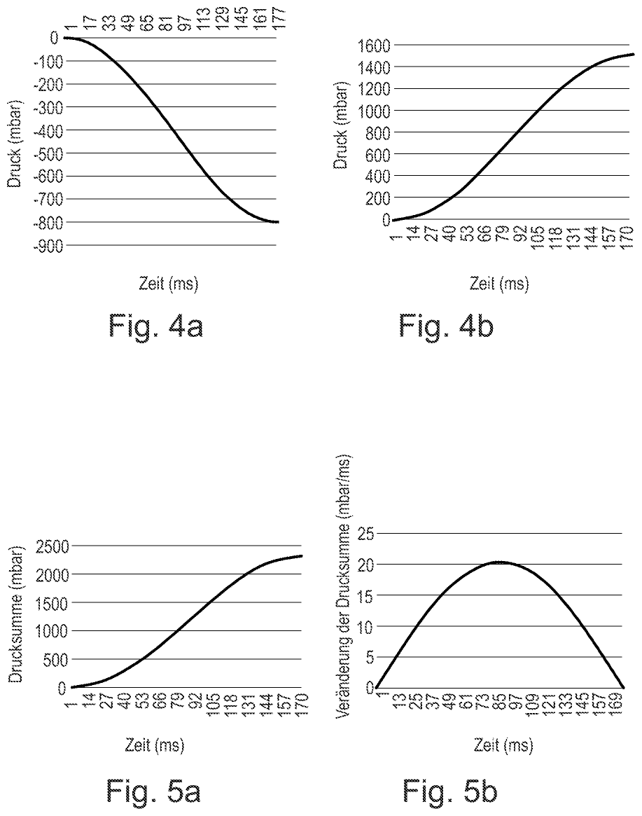

FIG. 4a shows the evolution of the vacuum pressure during activation,

FIG. 4b shows the evolution of the finish-blowing pressure during activation,

FIG. 5a shows the total pressure stretching the glass when the vacuum and the finish-blowing pressure are activated simultaneously,

FIG. 5b shows the change in the total pressure when the vacuum and the finish-blowing pressure are activated simultaneously,

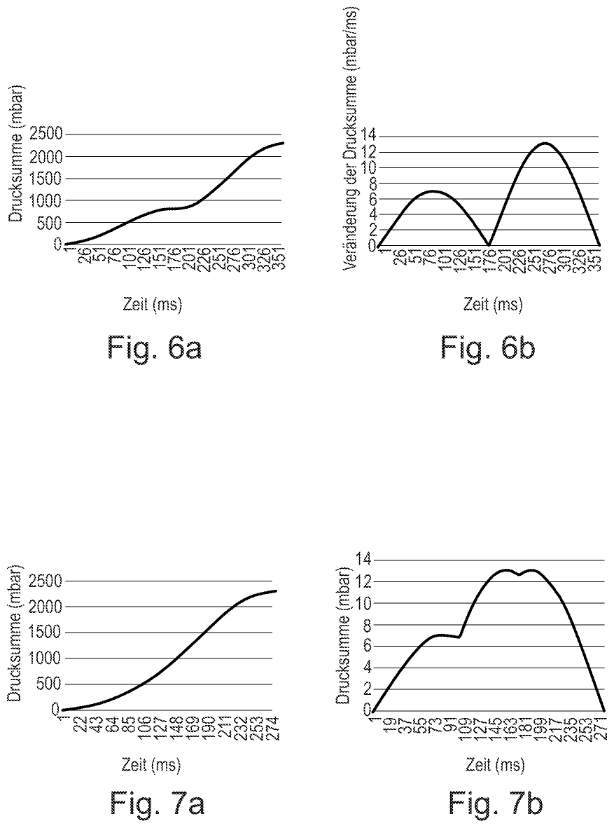

FIG. 6a shows the total pressure stretching the glass when the vacuum and the finish-blowing pressure are activated with a significant offset,

FIG. 6b shows the change in the total pressure when the vacuum and the finish-blowing pressure are activated with a significant offset,

FIG. 7a shows the total pressure stretching the glass when the vacuum and the finish-blowing pressure are activated with an optimum offset,

FIG. 7b shows the change in the total pressure when the vacuum and the finish-blowing pressure are activated with an optimum offset, and

FIG. 8 shows a flow diagram of a method according to the preferred exemplary embodiment of the invention.

FIG. 1 schematically shows an IS machine 1 according to a preferred exemplary embodiment of the invention, which is configured to produce glass containers, such as beverage bottles, in a blow-blow process. The IS machine 1 comprises a plurality of blank molds 2 and a plurality of finishing molds 3, one blank mold 2 interacting with one finishing mold 3 in each case. The sequence of the production method carried out by means of the IS machine is controlled by means of a machine controller 8.

All the blank molds 2 and all the finishing molds 3 are each equipped with valves and pressure sensors, such that, overall, a blank mold system 13 and a finishing mold system 14 is formed, specifically as follows. Each finishing mold 3 is equipped with a vacuum line 16 comprising a vacuum valve 4 for generating a vacuum in the finishing mold 3 and a vacuum pressure sensor 5 for measuring the vacuum pressure and with a finish-blowing feed line 15 comprising a finish-blowing valve 6 and a finish-blowing pressure sensor 7. In a similar manner, each blank mold 2 is equipped with a blowing-down feed line 17 comprising a blowing-down valve 9 and a blowing-down pressure sensor 10 and with a pre-blowing feed line 18 comprising a pre-blowing valve 11 and a pre-blowing pressure sensor 12.

According to the preferred exemplary embodiment of the invention described here, the following method for producing the glass containers is thus provided, and is schematically shown in FIG. 8. In this method, the method steps described in the following are carried out for each pair of one blank mold 2 and one finishing mold 3. This is described in the following on the basis of a single pair of one blank mold 2 and one finishing mold 3.

In a first method step S1, a glass gob is introduced into the blank mold 2. In method step S2, the glass gob is then blown down in the blank mold by means of compressed air blown into the blank mold 2 from the top through the blowing-down line 17. This supply of compressed air is controlled by actuating the blowing-down valve 9 by means of the machine controller 8. In method step S3, the glass gob is then pre-blown in the blank mold 2 to form a parison by means of compressed air blown into the blank mold 2 from the bottom through the blowing-down feed line 18. This supply of compressed air is controlled by actuating the pre-blowing valve 11 by means of the machine controller 8. When the parison is produced, the production process in the blank mold 2 is ended, such that, in method step S4, the blank is transferred into the finishing mold 3.

In this mold, in method step S5, the vacuum valve 4 is actuated for producing a vacuum in the finishing mold 3 from a first actuating point in time. Simultaneously, the evolution of the vacuum pressure is measured by means of the vacuum pressure sensor 5. Even before method step S5 is ended, method step S6 is started, in which a finish-blowing valve 6 is actuated for generating a finish-blowing pressure from a second actuating point in time that is later than the first actuating point in time by a predetermined duration. In this step, compressed air is blown into the finishing mold 3 from the top through the finish-blowing feed line 15, while the evolution of the finish-blowing pressure is simultaneously measured by means of the finish-blowing pressure sensor.

It is then important that, in method step S7, a check is carried out as to whether the evolution of the measured vacuum pressure and/or the evolution of the measured finish-blowing pressure has fulfilled a predetermined condition. The preferred exemplary embodiment of the invention described here provides various options for doing this, which are described in the following.

A preferred configuration of the invention is that, in step S7 of checking whether the evolution of the measured vacuum pressure and/or the evolution of the measured finish-blowing pressure has fulfilled a predetermined condition, a check is carried out as to whether the evolution of the measured vacuum pressure has a predetermined relation to the evolution of the measured finish-blowing pressure, and specifically to the effect that the duration between the points in time is determined at which the evolution of the finish-blowing pressure and/or the evolution of the vacuum pressure is at a maximum. Should it become clear here that the duration between the points in time at which the evolution of the finish-blowing pressure and/or the evolution of the vacuum pressure is at a maximum is not in a predetermined duration range, the time at which the vacuum valve 4 and/or the finish-blowing valve 6 is actuated is changed in a subsequent actuation in order to adjust the duration between the points in time at which the evolution of the finish-blowing pressure and/or the evolution of the vacuum pressure is at a maximum such that it is moved into the predetermined duration range. This duration range is the range between 100 and 120 ms in the present case. The background to this is as follows:

Both the vacuum that draws on the outside of the glass and the finish-blowing pressure during finish-blowing that acts in the inside are responsible for the stress to which the glass is exposed during finish-blowing in the finishing mold 3. The pressure gradient is primarily critical for this during the dynamic finish-blowing most of all, and less so the ultimate pressure that statically presses the glass into the finishing mold. In this process, the vacuum and blowing pressure for the glass wall are seen to act in the same direction.

In order to visualize this situation, in the present case, the two pressure curves of the pressure increase are considered to be sine functions in order to illustrate the effect of the pressure superposition. The static part of the finish-blowing is not seen here. A pressure of −800 mbar is assumed to be the vacuum and a pressure of 1500 mbar is assumed to be the blowing pressure. 180 ms is assumed to be the pressure build-up time. This results in pressure curves as shown in FIG. 4a for the evolution of the vacuum pressure and in FIG. 4b for the evolution of the finish-blowing pressure. If these two pressures are enabled by the machine controller 8, the precise point in time of the action in the finish-blowing feed line 15 and in the vacuum feed line 16 is dependent on different components. How the two pressure increases are superposed is thus not only determined by the actuation of the finish-blowing valve 6 and the vacuum valve 4, but instead results from the switching behavior of the entire signal chain. If the two pressure increases were precisely superposed, this would result in a pressure evolution and a pressure gradient evolution as shown in FIGS. 5a and 5b. As can be seen, this results in a maximum pressure gradient of 20 mbar/ms at an ultimate pressure of 2300 mbar.

If the vacuum valve 4 and the finish-blowing valve 6 were actually actuated such that the first pressure build-up is completed before the second pressure build-up starts, this would result in curves for the total pressure and for the change in the total pressure, as shown in FIGS. 6a and 6b. It can be seen from these figures that the maximum pressure gradient is then only approx. 13 mbar/ms, but, in this case, the total pressure build-up time is also at least twice as long, namely 360 ms. The ultimate pressure is again 2300 mbar; this does not change.

The aim is then to actuate the vacuum valve 4 and the finish-blowing valve 6, wherever possible, such that a pressure increase results which comes as close as possible to an optimum evolution. An optimization is thus sought according to which the two curves are superposed such that the pressure increase is limited while having the shortest possible pressure build-up time. A curve optimized in this way would then look as it does in FIGS. 7a and 7b, for example. Here, the start time for the finish-blowing is delayed by 110 ms compared with the start time for the vacuum being applied. It is clear that the pressure gradient is likewise at a maximum of 13 mbar/ms, but, by contrast with the above-described trivial solution, the total pressure build-up time has been shortened to 280 ms. The ultimate pressure is again 2300 mbar. A time delay to the actual actuation of both the vacuum valve 4 and the finish-blowing valve 6 of 110 ms is therefore optimal here. Therefore, the aim is to adjust this time difference, as described above, in a range of between 100 and 120 ms.

As already explained, the time difference between the pressure peaks, i.e. at the points in time at which the evolution of the finish-blowing pressure and/or the evolution of the vacuum pressure is at a maximum, is generally above 50 ms. In this respect, it is provided here that a glass container is rejected if a time difference between the pressure peaks of less than 50 ms has been identified for it. At a time of between e.g. 50 ms and 100 ms, a warning message is output to an operator of the IS machine, e.g. in the form of an optical and/or acoustic signal.

In the preferred exemplary embodiment of the invention described here, there is another option of, in the step of checking whether the evolution of the measured vacuum pressure and/or the evolution of the measured finish-blowing pressure has fulfilled a predetermined condition, carrying out a check as to whether the evolution of the total of the vacuum pressure and the finish-blowing pressure has not exceeded a predetermined maximum pressure. When it is indicated that the predetermined maximum pressure has been exceeded, the time at which the vacuum valve and/or the finish-blowing valve is actuated is changed in a subsequent actuation in order to adjust the evolution of the total of the vacuum pressure and the finish-blowing pressure such that the predetermined maximum pressure is no longer exceeded. In this case, the adjustment is set such that the ultimate pressure values of the vacuum pressure and the finish-blowing pressure are reached in the shortest possible time, which has already been explained above in principle on the basis of basic features.

Here too, in the event that the maximum pressure is only exceeded by a first predetermined pressure difference, a warning message is output, e.g. in the form of an optical and/or acoustic signal. If the maximum pressure is exceeded by a second predetermined pressure difference which is greater than the first predetermined pressure difference, the glass container during the production of which the second predetermined pressure difference was exceeded is rejected.

Another option in the preferred exemplary embodiment of the invention described in the present case involves carrying out additional method steps, which are carried out for a pair of one blank mold and one finishing mold in each case, and specifically as follows: The duration between the point in time of actuating the vacuum valve and the point in time at which the vacuum pressure has reached a predetermined vacuum pressure value is measured and the time at which the vacuum valve is actuated in a subsequent actuation is changed in order to adjust the duration between the point in time of actuating the vacuum valve and the point in time at which the vacuum pressure has reached a predetermined vacuum pressure value to a predetermined duration. The same is also possible during finish-blowing. Here, the duration between the point in time of actuating the finish-blowing valve and the point in time at which the finish-blowing pressure has reached a predetermined finish-blowing pressure value is measured and the time at which the finish-blowing valve is actuated in a subsequent actuation is changed in order to adjust the duration between the point in time of actuating the finish-blowing valve and the point in time at which the finish-blowing pressure has reached a predetermined finish-blowing pressure value to a predetermined duration.

Furthermore, in the preferred exemplary embodiment of the invention described here, it is an option to seek to optimize not only the finish-blowing, but also the pre-blowing. Specifically, in this case, in the step of blowing down the glass gob in the blank mold 2, the blowing-down valve 9 is actuated to generate the blowing-down pressure in the blank mold 2 from a third actuating point in time and the evolution of the blowing-down pressure is simultaneously measured, and, in the step of pre-blowing the glass gob in the blank mold 2 to form the parison, the pre-blowing valve 11 is actuated to generate the pre-blowing pressure in the blank mold from a fourth actuating point in time that is later than the third actuating point in time by a predetermined duration and the evolution of the pre-blowing pressure is simultaneously measured. Furthermore, the following method step is additionally provided, which is likewise carried out for all the pairs of one blank mold 2 and one finishing mold 3 in each case. In this step, a check is carried out as to whether the evolution of the measured blowing-down pressure and/or the evolution of the measured pre-blowing pressure has fulfilled a predetermined condition. In principle, an analogous approach can be taken to that which has been previously described in connection with the finish-blowing.

### LIST OF REFERENCE SIGNS

1 IS machine
2 blank molds
3 finishing molds
4 vacuum valve
5 vacuum pressure sensor
6 finish-blowing valve
7 finish-blowing pressure sensor
8 machine controller
9 blowing-down valve
10 blowing-down pressure sensor
11 pre-blowing valve
12 pre-blowing pressure sensor
13 blank mold system
14 finishing mold system
15 finish-blowing feed line
16 vacuum feed line
17 blowing-down feed line
18 pre-blowing feed line

1. Method for operating an IS machine for producing glass containers, wherein the IS machine comprises a plurality of blank molds and a plurality of finishing molds and one blank mold interacts with one finishing mold in each case, comprising the following method steps, which are carried out for a pair of one blank mold and one finishing mold in each case:
introducing a glass gob into the blank mold,
producing a parison from the glass gob in the blank mold,
transferring the parison into the finishing mold,
actuating a vacuum valve for producing a vacuum in the finishing mold from a first actuating point in time and simultaneously measuring the evolution of the vacuum pressure,
actuating a finish-blowing valve for generating a finish-blowing pressure from a second actuating point in time that is later than the first actuating point in time by a predetermined duration, such that compressed air is blown into the finishing mold from the top, and simultaneously measuring the evolution of the finish-blowing pressure and
checking whether the evolution of the measured vacuum pressure and the evolution of the measured finish-blowing pressure has fulfilled a predetermined condition.

2. Method according to claim 1, wherein in the step of checking whether the evolution of the measured vacuum pressure and/or the evolution of the measured finish-blowing pressure has fulfilled a predetermined condition, a check is carried out as to whether the evolution of the measured vacuum pressure has a predetermined relation to the evolution of the measured finish-blowing pressure.

3. Method according to claim 2, wherein in the step of checking whether the evolution of the measured vacuum pressure has a predetermined relation to the evolution of the measured finish-blowing pressure, the duration between the points in time is determined at which the evolution of the finish-blowing pressure and/or the evolution of the vacuum pressure is at a maximum.

4. Method according to claim 3, wherein in the event that the check indicates that the duration between the points in time at which the evolution of the finish-blowing pressure and/or the evolution of the vacuum pressure is at a maximum is not in a predetermined duration range, the time at which the vacuum valve and/or the finish-blowing valve is actuated is changed in a subsequent actuation in order to adjust the duration between the points in time at which the evolution of the finish-blowing pressure and/or the evolution of the vacuum pressure is at a maximum such that it is moved into the predetermined duration range.

5. Method according to claim 3, wherein in the event that the check indicates that the duration between the points in time at which the evolution of the finish-blowing pressure and/or the evolution of the vacuum pressure is at a maximum is lower than a predetermined upper duration limit, a warning message is output.

6. Method according to claim 3, wherein in the event that the check indicates that the duration between the points in time at which the evolution of the finish-blowing pressure and/or the evolution of the vacuum pressure is at a maximum is lower than a lower duration limit, the glass container during the production of which the duration fell below the lower duration limit is rejected.

7. Method according to claim 1, wherein in the step of checking whether the evolution of the measured vacuum pressure and/or the evolution of the measured finish-blowing pressure has fulfilled a predetermined condition, a check is carried out as to whether the evolution of the total of the vacuum pressure and the finish-blowing pressure has not exceeded a predetermined maximum pressure.

8. Method according to claim 7, wherein in the event that the check indicates that the predetermined maximum pressure has been exceeded, the time at which the vacuum valve and/or the finish-blowing valve is actuated is changed in a subsequent actuation in order to adjust the evolution of the total of the vacuum pressure and the finish-blowing pressure such that the predetermined maximum pressure is no longer exceeded.

9. Method according to claim 8, wherein the adjustment is set such that the ultimate pressure values of the vacuum pressure and the finish-blowing pressure are reached in the shortest possible time.

10. Method according to claim 7, wherein in the event that the maximum pressure is only exceeded by a first predetermined pressure difference, a warning message is output.

11. Method according to claim 7, wherein in the event that the maximum pressure is exceeded by a second predetermined pressure difference which is greater than the first predetermined pressure difference, the glass container during the production of which the second predetermined pressure difference was exceeded is rejected.

12. Method according to claim 1, comprising the following additional method steps, which are carried out for a pair of one blank mold and one finishing mold in each case:
measuring the duration between the point in time of actuating the vacuum valve and the point in time at which the vacuum pressure has reached a predetermined vacuum pressure value, and
changing the time at which the vacuum valve is actuated in a subsequent actuation in order to adjust the duration between the point in time of actuating the vacuum valve and the point in time at which the vacuum pressure has reached a predetermined vacuum pressure value to a predetermined duration.

13. Method according to claim 1, comprising the following additional method steps, which are carried out for a pair of one blank mold and one finishing mold in each case:
measuring the duration between the point in time of actuating the finish-blowing valve and the point in time at which the finish-blowing pressure has reached a predetermined finish-blowing pressure value, and
changing the time at which the finish-blowing valve is actuated in a subsequent actuation in order to adjust the duration between the point in time of actuating the finish-blowing valve and the point in time at which the finish-blowing pressure has reached a predetermined finish-blowing pressure value to a predetermined duration.

14. Method according to claim 1, wherein the step of producing the parison from the glass gob in the blank mold comprises the following method steps:
blowing down the glass gob in the blank mold by means of compressed air blown into the blank mold from the top and
pre-blowing the glass gob in the blank mold to form a parison by means of compressed air blown into the blank mold from the bottom, wherein
in the step of blowing down the glass gob in the blank mold, a blowing-down valve is actuated to generate a blowing-down pressure in the blank mold from a third actuating point in time and the evolution of the blowing-down pressure is simultaneously measured,
in the step of pre-blowing the glass gob in the blank mold to form the parison, a pre-blowing valve is actuated to generate a pre-blowing pressure in the blank mold from a fourth actuating point in time that is later than the third actuating point in time by a predetermined duration and the evolution of the pre-blowing pressure is simultaneously measured, and
the method comprises the following additional method step, which is likewise carried out for a pair of one blank mold and one finishing mold in each case:
checking whether the evolution of the measured blowing-down pressure and/or the evolution of the measured pre-blowing pressure has fulfilled a predetermined condition.
